(19) United States
(12) Patent Application Publication
(10) Pub. No.: US 2024/0103656 A1
(43) Pub. Date: Mar. 28, 2024

(54) MULTI-MODE MOUSE

(71) Applicant: Apple Inc., Cupertino, CA (US)

(72) Inventors: Bart K. Andre, Palo Alto, CA (US); Brian T. Gleeson, Mountain View, CA (US); Kristi E. Bauerly, Los Altos, CA (US); William D. Lindmeier, San Francisco, CA (US); Matthew J. Sundstrom, Campbell, CA (US); Geng Luo, Santa Clara, CA (US); Seung Wook Kim, San Jose, CA (US); Evangelos Christodoulou, Santa Clara, CA (US); Megan M. Sapp, San Francisco, CA (US); Kainoa Kwon-Perez, San Francisco, CA (US); David H. Bloom, San Francisco, CA (US); Steven J. Taylor, San Jose, CA (US)

(21) Appl. No.: 18/472,177

(22) Filed: Sep. 21, 2023

Related U.S. Application Data
(60) Provisional application No. 63/376,763, filed on Sep. 22, 2022.

(51) Int. Cl. G06F 3/041; G06F 3/0346; G06F 3/0354; G06F 3/044

(52) U.S. Cl. CPC G06F 3/04144; G06F 3/0346; G06F 3/03543; G06F 3/044; G06F 2203/04105

(57) ABSTRACT

An input device, such as a mouse, can include a housing defining an exterior grip portion and an internal volume, a sensor assembly disposed in the internal volume, and an emitter electrically coupled to the sensor assembly. In response to the sensor assembly detecting a first touch input on the housing, the emitter sends a first signal including information regarding an angular position of the grip portion. In response to the sensor assembly detecting a second touch input on the housing, the emitter sends a second signal including information regarding a direction of a force exerted on the housing from the second touch input.

### CROSS-REFERENCE TO RELATED APPLICATION(S)

This claims priority to U.S. Provisional Patent Application No. 63/376,763, filed 22 Sep. 2022, and entitled “Multi-Mode Mouse,” the disclosure of which is hereby incorporated by reference in its entirety.

### FIELD

The described embodiments relate generally to input devices. More particularly, the present embodiments relate to input devices with multiple modes.

### BACKGROUND

Computer systems and devices, such as portable computers, tablets, desktop computers, and so forth, receive input from a user via an input device such as a mouse, trackpad or other input device. The input device allows a user to move an input pointer (i.e., cursor) and make selections in a graphical user interface (GUI) on the computer system. The input device generally includes buttons and a motion tracking component, for example, a mechanical or optical tracker or other movement tracker. The motion tracking component can track user directed movements of the input device, translating the user's movement into signals readable by a computer system. For example, a user may wish to select a feature displayed on a GUI. The user can direct an input device that translates the user's motion to a cursor on a screen toward the desired feature displayed on the GUI. Then, the user can depress or tap buttons on the input device to make the desired selection.

Conventional user input devices may include mechanical buttons for data selection and command execution. The mechanical buttons are located in a fixed location on the user input device creating an orientation specific user interaction between the user input device and the user. This orientation specific user interaction limits the user from interacting with the user input device in ways that may be more efficient, reducing user productivity and, in some cases, frustrating the user. In addition, the buttons and input functionalities of traditional input devices limit the ways in which the user can interact with the input device. Some input devices may include a variety of buttons and selectors, including joysticks and turn-knobs, but require additional components that complicate manufacturing and add to costs. These additional buttons, knobs, and joysticks enabling different input modes from the user also introduce more moving parts, which can lead to increased failure rates.

Therefore, what is needed in the art are input devices capable of providing improved user experiences with multiple input modes without the need for additional components and moving parts.

### SUMMARY

A In at least one example of the present disclosure, an input device includes a housing having an interior surface defining an internal volume, a touch sensor assembly including an array of capacitive sensing elements disposed against the interior surface, an orientation sensor disposed in the internal volume, and a force sensor assembly configured to detect a direction of a force exerted on the housing.

In one example, force sensor assembly is configured to detect a first hand position of a user touching the housing based on a first set of capacitive sensing elements detecting contact between the hand and the housing and detect a second hand position of a user touching the housing based on a second set of capacitive sensing elements detecting contact between the hand and the housing. In one example, the orientation sensor can detect a rotation of the input device in response to detecting the first hand position and the force sensor detects the direction of the force exerted on the housing in response to detecting the second hand position. In one example, the input device includes a touch sensor assembly configured to detect a hand position of a user touching the housing. In one example, the touch sensor assembly includes two sensor elements disposed on the interior surface. In one example, the force sensor assembly includes two force sensors. In one example, the orientation sensor includes (IMU, compass . . . etc.). In one example, the input device further includes a feedback module. In one example, the feedback module includes a haptic mechanism. In one example, the feedback mechanism includes a speaker.

In at least one example of the present disclosure, a mouse includes a housing including a base and a grip portion coupled to the base, a plurality of touch sensors disposed on the grip portion, and a force sensor disposed on the base portion, the force sensor sensitive to a direction and magnitude of a force applied to the grip portion.

In one example, the mouse further includes grip detection. In one example, the mouse further includes a processor electrically coupled to the plurality of touch sensors and the force sensor. In one example, the mouse further includes an emitter electrically coupled to the processor, wherein when the plurality of touch sensors detects a first hand position contacting the grip portion, the emitter sends information regarding a direction to force applied on the grip portion detected by the force vector sensor and when the plurality of touch sensors detects a second hand position contacting the grip portion detected by the force vector sensor and when the plurality of touch sensors detects a second hand position contacting the grip portion, the emitter sends information regarding an orientation of the mouse. The mouse further includes an orientation sensor electrically coupled to the processor.

In at least one example, a mouse can include a housing defining an exterior grip portion and an internal volume, a sensor assembly disposed in the internal volume, and an emitter electrically coupled to the sensor assembly. In such an example, in response to the sensor assembly detecting a first touch input on the housing, the emitter sends a first signal including information regarding an angular position of the grip portion. Also, in such an example, in response to the sensor assembly detecting a second touch input on the housing, the emitter sends a second signal including information regarding a direction of a force exerted on the housing from the second touch input.

In one example, the first touch input includes a set of touch input locations on the housing. In one example, the second touch input includes a single touch location. In one example, the sensor assembly includes a force vector sensor, a touch sensor array, and an angular sensor. In one example, the touch sensor array includes a plurality of capacitive sensing elements configured to detect the first touch input and the second touch input. In one example, the force vector sensor includes a first force sensor disposed at a first location with the internal volume and a second force sensor disposed at a second location within the internal volume.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective view of a mouse and a display;

FIG. 2A shows a perspective view of a mouse;

FIG. 2B shows a bottom perspective view of a mouse;

FIG. 2C shows a top view of a mouse and a plane;

FIG. 3 shows a side cutaway view of a mouse and various sensors;

FIG. 4 shows a side cutaway view of a mouse and various sensors;

FIG. 5 shows a side cutaway view of a mouse with sensors.

FIG. 6 shows a top cutaway view of a mouse;

FIG. 7 shows a perspective view of a mouse and a light array;

FIG. 8 shows a side cutaway view of a mouse with sensors;

FIG. 9A shows a mouse and a user's hand;

FIG. 9B shows a mouse detecting a hand position;

FIG. 10A shows a mouse and a user's hand;

FIG. 10B shows a mouse detecting a hand position;

FIG. 11A shows a mouse and a user's hand; and

FIG. 11B shows a mouse detecting a hand position.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to input devices. More particularly, the present embodiments relate to input devices, such as a mouse, that have multiple modes of input. Input devices allow a user to interact with a digital environment by interacting with a computing device (e.g., portable computer, desktop computer, tablet, etc.) and a display via the input device. The input device allows the user to move an input pointer (e.g., cursor) to make selections in a graphical user interface (GUI) on the display of the computing device. Input devices generally include buttons and a location tracking device (e.g., mechanical movement tracker, optical movement tracker, or an array of sensors identifying a user input). As the input device is moved, for example translated across a support surface such as a mousepad or desktop surface, the input device tracks the user induced movement to generate signals readable by the computing device, which then presents the motion of the input device on a display as represented by a cursor or other visual object.

In some instances, a user may wish to make a selection shown on a display. A conventional user input device requires the user to interact with a specific location of the user input device to make a selection, for example, clicking a button while hovering over an icon to generate a signal readable by the computing device. Generally, a button has a specific input programmed by the manufacturer and is difficult to change or is unchangeable. The button location and fixed functions of the button create a simple user-device interaction.

Unfortunately, many users require more advanced button functions and prefer buttons in different locations. The fixed location of the buttons on the user input device creates a frustrating experience, forcing the user to grip the user input device in a way that can be uncomfortable or undesired. Additionally, buttons located in a fixed location create a difficult user experience for a left handed user and a right hanged user sharing the same user input device, since the buttons of the user input device may have fixed functions (e.g. left-click and right-click buttons) and locations.

Additionally, a conventional user input device is limited in orientation and functionality, for example, the user input device may have a fixed coordinate system, forcing a user to properly orient the user input device to generate the user's intended movement direction.

While having a user input device is advantageous for interacting with a computing device, as described above, conventional user input devices fail to have a dynamic coordinate system that adapts to the user and have fixed button locations that cannot actively adjust to the user's change in hand position. The examples of input devices described herein below detail a user input device with features and function relative to button placement and cursor position that create a more satisfying and interactive user experience. In addition, these features enable the input devices described herein to detect and interpret multiple types of user interactions, depending on how the user grips the device, to switch operational modes.

In at least one example, an input device includes a housing including an interior surface defining an internal volume. The input device further includes an orientation sensor disposed in the internal volume and a force sensor assembly. The force sensor and force sensor assembly are configured to detect a direction of a force exerted on the housing. For example, a user may place his or her finger on the housing and press in a certain direction with a certain amount of force. The input device can detect the user force vector (e.g., direction and magnitude of the force) causing the cursor to move in the user intended direction.

In another example, an input device, such as a mouse, includes a housing including a base and a grip portion coupled to the base. The input device further includes a plurality of touch sensors disposed on the grip portion. The base portion includes a force vector sensor capable of detecting user input disposed on the base portion.

In such examples, the input device can be said to operate in a joystick mode, where, based on the detected finger position pressing on the device, the device itself can be manipulated as a joystick would be to control the cursor.

In another example, the user input device (e.g., a mouse) includes a housing defining an internal volume, a sensor assembly, and an electrical component configured to send a user interface signal. The sensor assembly can detect a first touch input (e.g. a user's finger or hand) on the housing translating the first touch input via the electrical component into a user interface signal. The user interface signal includes information regarding the angular position of the grip portion. The sensor assembly can detect a second touch input (e.g. a force exerted by a user's finger or hand) on the housing. The user interface signal includes a direction of a force exerted on the housing from the second touch input.

In such an example, the input device can be said to operate in a turn-knob or dial mode, where, based on the detected finger positions pressing on the device, the device itself can be manipulated or twisted as a dial would be to control the cursor or make selections on a display screen. In addition, the input device can switch from one mode to another, for example between a traditional mode, a joystick mode, and a dial mode, automatically based on the detected hand position of the user contacting the input device. The functionalities of the input device in each mode do not require different or unique buttons, knobs, or joysticks since the sensor array can assign any location contacted by the user to a functional input region or contact location. Thus, the complexity of the input device is reduced while the functionality of different operational modes is increased.

Accordingly, electronic input devices, described herein, including a computer mouse, can create a more satisfying and interactive user experience by including multiple input modes without the need for additional components and moving parts.

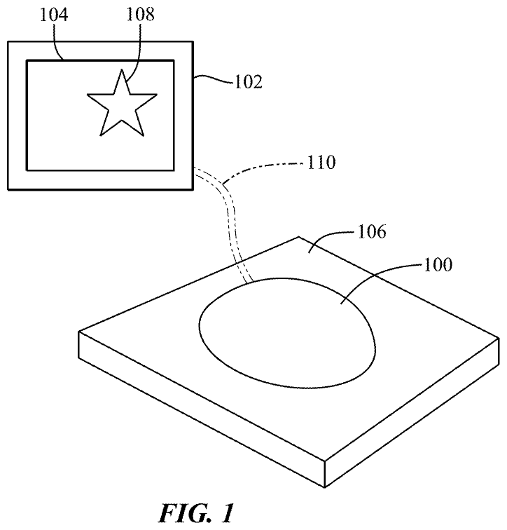

These and other embodiments are discussed below with reference to FIGS. 1-11B. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates an input device 100 located on a support surface 106 being connected via a connector 110 to a computing device 102. The input device 100 can also be referred to herein as a mouse 100. The connector 110 is shown in broken lines to indicate that the connector 110 is optional. In one example, the mouse 100 can be wirelessly connected to the computing device 102. The computing device 102 can include a display screen 104 and an input pointer (e.g., a cursor) 108 displayed on the display screen 104. The mouse 100 can rest on a support surface 106 and be manipulated by a user interacting with the computing device 102 (e.g., a computer system). A processor in the mouse 100 or in the computing device 102 can transmit the user induced movement of the mouse 100 to the cursor 108 on the display screen 104 of the computing device 102, thus controlling the cursor 108 on the display screen 104.

The term “mouse” is intended to describe an electronic input device or circular user input device that is described herein as a mouse 100. In one or more examples, the electronic input devices or circular user input devices described herein, including the mouse 100, can be a remote control, volume control, pointer, or other electronic input device capable of providing control signals to an electronic device like the computing device 102 shown in FIG. 1.

The mouse 100 can interact with a variety of electronic devices (e.g. laptops, tablets, televisions, virtual reality headsets, etc.) providing a diverse set of functions to users. The mode of the mouse 100 can change corresponding to the connection between the mouse 100 and an electronic device. For example, the mouse 100 can act as a mouse for a computer and switch (dynamically or manually) between devices to interact with a television set or other electronic device or computing system.

The mouse 100 can be connected to the computing device 102 via the connector 110. In one example, the connector 110 can be a cable (e.g. a plurality of wires for transmitting energy, signals, or other interface data) creating a wired connection between the mouse 100 and another electronic device (e.g. computer, display, television, etc.). In one example, the connector 110 between the mouse 100 and the computing device 102 or other electronic device can be wireless (BLE, RF, WLAN, LAN, WPAN, etc.) electronically communicating movements of the mouse 100 to the computing device 102 or other electronic device.

A user can grip the mouse 100 in a variety of grip configurations and hand positions. For example, a user can use a left hand to grip electronic device 100 in one instance and a right had to grip the mouse 100 in another instance. In another example, the user can grip the mouse 100 with all five fingers and a portion of his or her palm. In another example, the user can grip the mouse 100 with only two or three fingers. The mouse 100 can actively and automatically reorient which direction corresponds to direction of the cursor 108 on the display screen 104 based on the position of the user's hand. Additionally, as will be described in greater detail below with reference to other figures, the circular design of the mouse 100 allows the user to grip the electronic input device in different orientations without having to physically reorient the mouse for use or interrupt functionality.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

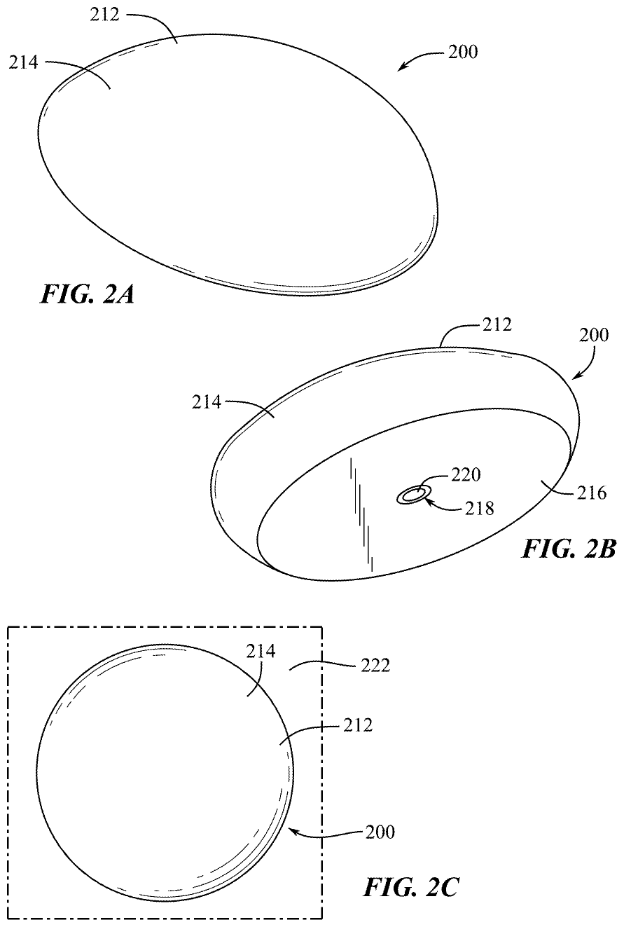

FIGS. 2A and 2B illustrate top and bottom perspective views, respectively, of a mouse 200 including a grip surface 214, a lower portion defining a lower surface (e.g., contact surface) 216, and a housing 212. The mouse 200 can be an example embodiment of the mouse 100 of FIG. 1. The lower surface 216 is configured to rest on a support surface 106 whereby the mouse 200 can be slidably translated from one position to another position by a user. The mouse 200 further includes a motion sensor 220 (e.g., an optical location, position, or movement sensor (e.g., an infrared sensor), a mechanical location sensor (e.g., a mouse ball), a laser location, position, or movement sensor, a similar device, or combinations thereof) aligned with an aperture 218 defined in the lower surface 216. The motion sensor 220, aligned with the aperture 218, can detect the support surface 106 and movement (changes in location) of the mouse 200 on the support surface 106 through the aperture 218.

FIG. 2C shows a top view of the mouse 200 wherein the housing 212 defines a circular shape or circular outer perimeter around a major cross-sectional plane 222, otherwise referred to as the major plane 222. In at least one example, the major plane 222 can be parallel to the lower surface 216. The circular cross-sectional shape of the mouse 200 in the major plane 222 can be centered on a central axis 223 extending normal to the major plane 222. The lower surface 216 can be secured to the grip surface 214 of the housing 212, and the major plane 222 and the lower surface 216 can be parallel to each other.

In at least one example, the grip surface 214 can be composed of materials (e.g. plastics, metals, rubbers, etc.) being penetrable by signals detected by capacitive sensors or other sensor types. Accordingly, in at least one example of the mouse 200, one or more sensors, such as touch sensors, can be disposed within the mouse 200 and configured to detect a user's contact (e.g., from a finger, palm, wrist, etc.) with the grip surface 214 through the housing 212. In addition, at least one embodiment of the mouse 200 can include a transparent or semi-transparent material such that light can project through the housing 212 and display feedback or other information to a user.

Any of the features, components, and/or parts, including the arrangements and configurations thereof shown in FIGS. 2A-2C, can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2A-2C.

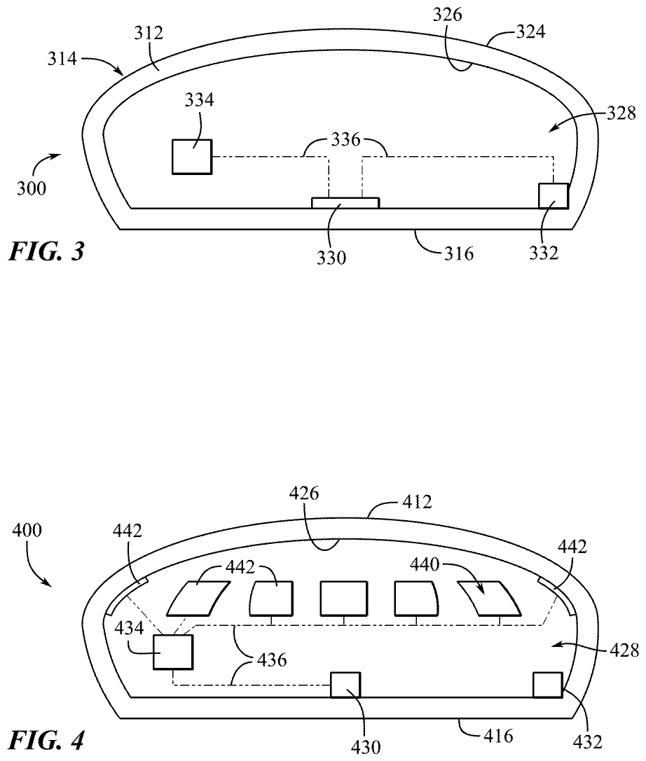

FIG. 3 shows a side cutaway view of the mouse 300 (e.g. input device) including the housing 312 with an exterior surface (e.g. outer surface) 324 and an interior surface (e.g. inner surface) 326 defining an internal volume 328. The housing 312 can include an upper portion/grip portion 314 and a lower portion 316 configured to rest on, or to be parallel to, a support surface while the mouse 300 is used. In at least one example, the mouse 300 can also include an orientation sensor 330 disposed in the internal volume 328 and a force sensor assembly 332. The force sensor assembly 332 and the orientation sensor 330 can be connected via at least one electrical connection 336 to a processor 334. The processor 334 can process signals transmitted from the force sensor assembly 332 and the orientation sensor 330.

The term “force sensor” (e.g. strain gage force sensor, thin-film force sensor, piezoresistive force sensor, hydraulic force sensor, load cell force sensor, etc.) within the context of this application refers to a sensor that senses an input mechanical force (e.g., load force, weight force, tension force, compression force, torsional force, pressure force, etc.) and produces an output such as a measureable electrical output signal. The electrical output signal is converted and standardized such that as a mechanical force increases or decreases, the electrical signal changes (e.g., proportionally to the increase or decrease in mechanical force). For example, a user may apply pressure to the housing 312 of the mouse 300 such that the force sensor assembly 332 detects a change in mechanical force. The change in mechanical force is converted to an electrical signal and transmitted via the connection 336 to the processor 334 that processes the electrical signal to determine the direction of force exerted on the mouse 300.

The force sensor assembly 332 can include one or more force sensors configured to sense a direction and/or magnitude of a force applied to the housing 312. In one example, the force sensor assembly 332 can include two or more sensors disposed at an interface between the grip portion 314 and the lower portion 316, for example disposed on the lower portion 316 where the grip portion 314 meets the lower portion 316, to detect a magnitude of force applied to the housing 312 that urges the grip portion 314 against the lower portion 316. In on example, multiple force sensors of a force sensor assembly 332 can each detect a magnitude of the applied force and the direction of that force can be calculated based on the positions of the sensors and the respective magnitudes detected. In at least one example, the force sensor assembly 332 can include one or more strain gauges disposed on the housing 312 to detect a deformation of the housing 312 material as the user presses thereon with a force.

The term “orientation sensor” (e.g. accelerometer, gyroscope, magnetometer, compass, inertial measurement unit (IMU), etc.) within the context of this application refers to a sensor or combination of sensors that detect an input device's (e.g. a mouse 300) orientation in three-dimensional space. For example, an orientation sensor can measure specific force, angular rate, angular velocity, linear acceleration, etc. with respect to an axis, a gravitational direction, a magnetic field (e.g., earth's magnetic field), other signals (e.g., relative to global positioning system (GPS) signals or nearby short-range electronic signals (e.g., WI-FI®, BLUETOOTH®, near-field communications (NFC) emitters, etc.)). The orientation sensor 330 can be a combination of orientation sensors, for example, an accelerometer may detect acceleration in a certain direction, a gyroscope may detect angular velocity, and a magnetometer may detect a magnetic field (e.g., direction relative to an object such as earth). The orientation sensed can be a relative orientation, an absolute orientation, a geomagnetic orientation, other orientation types, or combinations thereof depending on the types of sensors present and active when the input device orientation is detected.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

FIG. 4 illustrates a side cutaway view of a mouse 400 including a housing 412, an interior surface 426 of the housing 412 defining an internal volume 428, a touch sensor assembly 440, an orientation sensor 430, a force sensor assembly 432, a base 416, and a processor 434.

The processor 434 can perform actions by executable instructions stored or encoded therein on memory. In some embodiments, the processor 434 can be part of a controller device positioned in the housing 412 which includes a processor in electronic communication with a non-transitory computer-readable memory device or similar electronic storage device configured to store thereon a set of instructions executable by the processor to perform a series of tasks or actions. Any kind and/or number of processor(s) 434 may be present, including one or more central processing unit(s) (CPUs), digital signal processors (DSPs), microprocessors, computer chips, and/or processing units configured to execute machine-language instructions and process data, such as executable instruction, transmit sensor data, or transmit location and/or force vector data transmitted by sensors. The processor 434 can be coupled to the touch sensor assembly 440 via an electrical connection 436. The processor 434 can be configured to determine an orientation of the mouse 400 based on touch input (e.g. via a set of capacitive sensing elements, force sensing elements, or other input elements) detected by a sensor (e.g. a touch sensor 443, orientation sensor 430, force sensor 432, etc.)

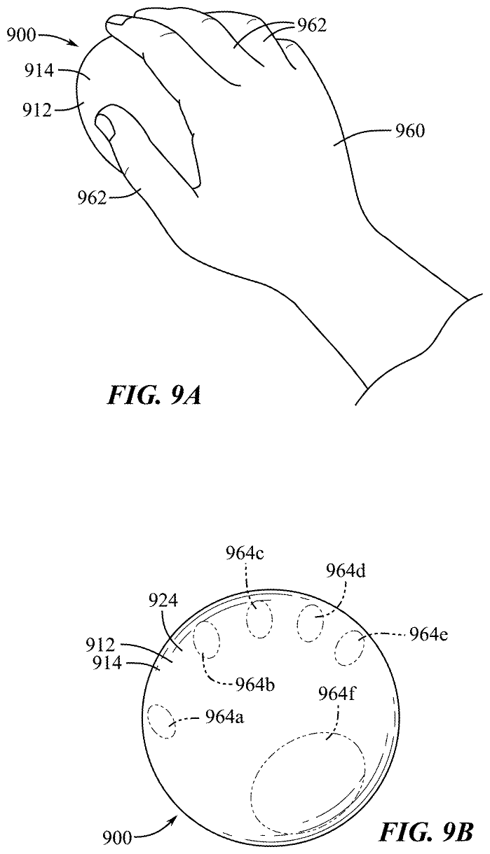

The touch sensor assembly 440 can be configured to detect a hand position of a user touching the housing 412, as shown in FIGS. 9A-11A. The touch sensor assembly can 440 include at least two sensor elements 442 disposed on the interior surface 426. In one example, the touch sensor assembly 440 includes at least two sensor elements 442 disposed on the interior surface 426 of the housing 412 wherein the touch sensor assembly includes a plurality of capacitive sensing elements 442 configured to detect touch inputs. The capacitive sensing elements 442 can in transmit a signal to the processor 434 coupled to the sensor assembly 440 whereby the processor 434 can process the signal from the touch inputs of the user.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

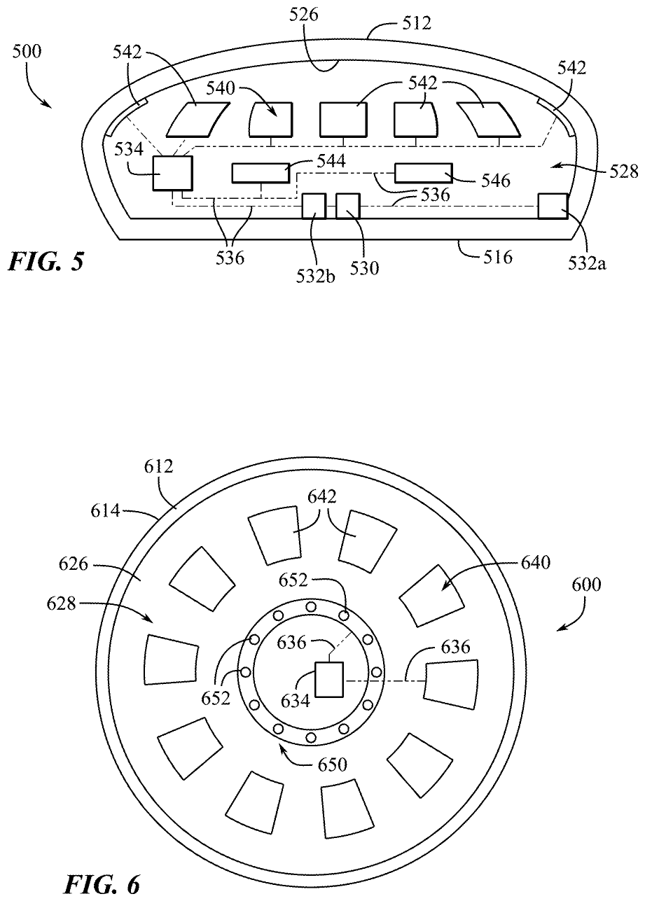

FIG. 5 shows a side cutaway view of a mouse 500 including the housing 512 defining a grip portion 514 and a lower portion or base 516 configured to rest on or move parallel to a support surface during use. The housing 512 can include an interior surface 526 defining an internal volume 528 and a touch sensor assembly 540 including a plurality of touch sensors 542, a force sensor assembly (including, for example, first and second force sensors 532a and 532b), an antenna 546, which can also be referred to as an emitter, receiver, or wireless communications module, and a feedback module 544 connected via the connection 536 to the processor, can be disposed in the internal volume 528. The feedback module 544 can include one or more of a haptic mechanism including a haptic motor, a light, and a speaker. These feedback modules 544 can use tactile, visual, or audio feedback means, respectively, to communicate with the user. Feedback communications can convey mouse or computing device information to the user of the mouse 500 such as confirmatory signals, power status, operational mode status, and so forth.

The force sensor assembly 532 includes at least two force sensors 532a, 532b disposed on the lower portion 516 of the mouse 500 and within the internal volume 528 at a first location and a second location, respectively. The force sensors 532a, 532b can detect one or more forces exerted on the housing 512, for example from a user's hand or fingers, such as by compression of the housing 512 between the hand and a support surface under the lower portion 516. The force sensors 532a, 532b can be independent from the one another. In one example, the force sensor 532a located at the first location can detect an X-component of the force vector and the force sensor 532b located at the second location can detect a Y-component of the force, with the X and Y directions being oriented perpendicular to one another. The magnitude of the force in either direction (or as a vector combining both directions) can also be detected by the two force sensors 532a, 532b.

In one example, a user may press their finger in a certain direction with a certain force against the housing 512. The force vector detected by the force sensors 532 can then be transmitted to the processor 534 and processed in real-time to interpret the force vector information as a movement, click, or other function of a cursor on a display screen, such as the cursor 108 on the display screen 104 shown in FIG. 1. In another example, a user may press multiple fingers with a certain force against the housing 512 to produce a function different from one lone finger pressing against the housing 512. It should be appreciated that the above examples are provided to illustrate the function of the force sensors 532 and other embodiments are contemplated herein. Additional detail about detecting and responding to user input is discussed in connection with FIGS. 9A-11B herein.

In some examples, the force sensor assembly 532 can include two force sensors 532a, 532b, as discussed above. The force sensor assembly 532 includes a feedback module 544 wherein the feedback module 544 includes a speaker and a haptic mechanism creating an experience of touch by applying forces, vibrations, or motions to a user. The haptic mechanism of the feedback module 544 can include a haptic engine. The haptic engine can include electromechanical components or devices that vibrate, shake, or pulsate, providing tactile feedback to a user via the housing 512. The haptic engine can include linear resonant actuators (LRA) (e.g., a combination of multiple LRAs) to create motion or tactile feedback in one or more axes relative to the mouse 500. Similarly, the haptic engine can include one or more eccentric rotating mass (ERM) motors to create motion or tactile feedback in one or more axes relative to the mouse 500. These haptic components can be driven by different waveforms to create distinct haptic effects representing different functions. For example, when the mouse 500 rotates about its central vertical axis, an audible sound or vibration resembling a turn-dial or knob can be produced. In another example, a user may tap the mouse 500 with a finger to select a feature or icon on the surface of the mouse or, via a cursor, on a connected display screen. The feedback module 544 of the mouse 500 can create a different sound or haptic effect differentiating a user tap or click from a rotation of the mouse 500. In some examples, the haptics can have a resolution (e.g. detent resolution) that can be user varied according to a certain user need or specification. In another example, audio signals produced by music, games, movies, or other digital media can be converted to haptic effects and relayed to the user via the feedback module 544. In some embodiments, the mouse 500 can be used as a speaker to play back audio media. It should be appreciated that other embodiments are contemplated herein and the above description provides examples to illustrate the feedback module 544.

The sensor assembly can include the force vector sensor(s) 532a and 532b, the touch sensor array (e.g. touch sensor assembly 540), and the orientation sensor 530 (e.g. angle or displacement sensors). For example, the sensor assembly disposed within the mouse 500 senses a user interacting with the mouse 500, which can include a user touching the mouse 500 (and thereby changing capacitance or resistance in a touch sensor), applying pressure to the mouse 500 (and thereby affecting a piezoresistive sensor element), and/or jostling or manipulating the mouse 500 (and thereby affecting an accelerometer, compass, gyroscope, or similar IMU sensor). The various sensors 532a, 532b, 540, 530 can transmit signals (e.g., touch signals, pressure vector signals, angular signals relative to an axis, etc.) to the processor 534, which converts the sensor signals into computer readable outputs which can be presented on the display 104 and/or represented by the cursor 106.

In some examples, the mouse 500 includes the housing 512 defining the internal volume 528, the sensor assembly, and an electrical component configured to send a user interface signal. In some examples, the user interface signal is transmitted via an antenna 546, otherwise generally referred to as an emitter. When the sensor assembly detects a first touch input on the housing 512, the user interface signal can include information regarding the angular position of the grip portion (e.g., grip surface 214), and when the sensor assembly detects a second touch input on the housing 512, the user interface signal can include a direction of a force exerted on the housing 512 from the second touch input. Each of the first and second touch inputs referred to above can include distinct combinations of contact regions of the user's hand and fingers against the housing 512 of the mouse 500 as detected by the touch sensor assembly 540.

The antenna 546 or other wireless interface module of the mouse 500 may include PCB antennas, wire antennas, chips antennas, or any other type of suitable antenna configuration. The antenna 546 may include monopole, dipole, patch, slot, planar inverted-F (PIFA), or any other type of antenna suited for omnidirectional antenna radiation and reception, which is advantageous for short-range connectivity and unpredictable access points that vary in location relative to the user, or large sector directional radiation and reception such as hemispherical patterns. Additionally, antenna arrays can also be implemented to steer radiation/reception patterns to affect connectivity. The antenna 546 can operate at, or be optimized for, specific frequencies (e.g., 2.4 GHz or 5 GHz) and/or radio frequency (RF) bands. The antenna can be a BLUETOOTH® device transmitting at a similar frequency (e.g., 2.4 GHz). It should be understood that other embodiments of antennas are contemplated and the above description provides examples.

In another example, the mouse 500 includes a base 516 and a grip portion (e.g. housing 512) couples to the base 516. A plurality of touch sensors 542 are attached to the grip portion. For example, the touch sensor(s) 542 can be disposed within the internal volume 528 and against the interior surface 526 of the housing 512. The force vector sensor(s) 532a, 532b can be disposed on the base 516 or within the base 516. The mouse 500 can further include the processor 534 electrically coupled (e.g., via the connection 536) to the plurality of touch sensors 540 and the force sensor 532. The emitter 546 can also be electrically coupled to the processor 534.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

FIG. 6 illustrates a bottom cutaway view of the mouse 600 including a housing 612 including a grip portion 614, a sensor assembly 640, a light array 650, and a processor 634 communicatively coupled to the sensor assembly 640 and a light array 650 via an electrical connection 636. Certain electrical connections (e.g., 536) are omitted. The housing 612 can include an interior surface 626. The interior surface 626 can define an internal volume 628. The sensor assembly 640 and the light array 650 can be disposed in the internal volume 628. In one example, the light array 650 can be located concentrically within the internal volume 628 and disposed on the interior surface 626. The light array 650 can include multiple individual LEDs 652 arranged in a circular shape having a first diameter. The sensor assembly 640 can be arranged circularly and located concentrically within the housing, disposed on the interior surface 626, and include a second diameter. In some embodiments, the first diameter is smaller than the second diameter (as shown in FIG. 6), and in some embodiments, the second diameter is smaller, wherein the light array 440 surrounds the sensor assembly 430. Additionally, in some embodiments, the light array 440 and sensor assembly 430 have substantially equal and concentric diameters, wherein individual lights 442 are spaced between or overlapping with capacitive sensor elements 432.

In one example, the mouse 600 (e.g. electronic input device) includes the housing 612, a circular sensor array 640 including a plurality of capacitive sensor elements 642 disposed against or embedded within the interior surface 628 of the housing 612, and a circular light array 650 disposed against the interior surface 628 of the housing 612. In at least one example, the circular light array 650 includes a plurality of light emitting diodes (LEDs) 652 (e.g., DIP LED, SMD LED, COB LED, similar light sources, and combinations thereof) oriented in a circle concentric with the circular sensor array 640. In at least one example, the sensor array 640 can include a plurality of sensor elements 642. In one example, the sensor elements 642 can include capacitive touch sensor elements.

The housing 612 can be a transparent or semi-transparent material such that when an LED 652 on the circular light array 650 is energized, emitting visible spectrum light, the light is visible to a user through the housing 612 external to the mouse 600. The LED 652 can vary in light intensity and color. For example, the light array 650 can provide notifications (e.g. text message notification, calendar notification, time notification, etc. for a connected computing device) corresponding to a hue, brightness, saturation, blinking or color pattern, or similar light indicator property. In another example, the LED 652 can provide indicators such as device battery life, device orientation, or other indicators. In at least one example, the LEDs 652 of the light array 650 can be synchronized over time to produce animated light appearing to move one way or the other to communicate with the user (e.g., in patterns moving around the circumference of the circle).

In one example, the processor 634 is configured to display a direction of the orientation of the mouse 600. For example, as the mouse 600 is rotated about the normal/vertical axis 223 while having its bottom surface 216 parallel to the support surface 106, an LED 652 located on the circular light array 650 can illuminate, and the light can shift from a first energized LED 652 to a second energized LED 652, with the first LED 652 becoming de-energized as the second LED 652 is energized. In this way, as the mouse 600 is rotated, the energized LED 652 can appear to remain in one location relative to the user's viewing perspective.

In another example, the processor 634 is configured to display a mode in which the mouse 600 is operating. The mode can depend on a hand position of the user grasping the mouse 600 and can switch automatically upon sensing the contact between the user's hand and the housing 612 via the sensor assembly 640. As noted elsewhere herein, the various operational modes of the mouse 600 can include a joystick mode, a dial mode, or a traditional mouse mode depending on how the user grasps the mouse 600.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

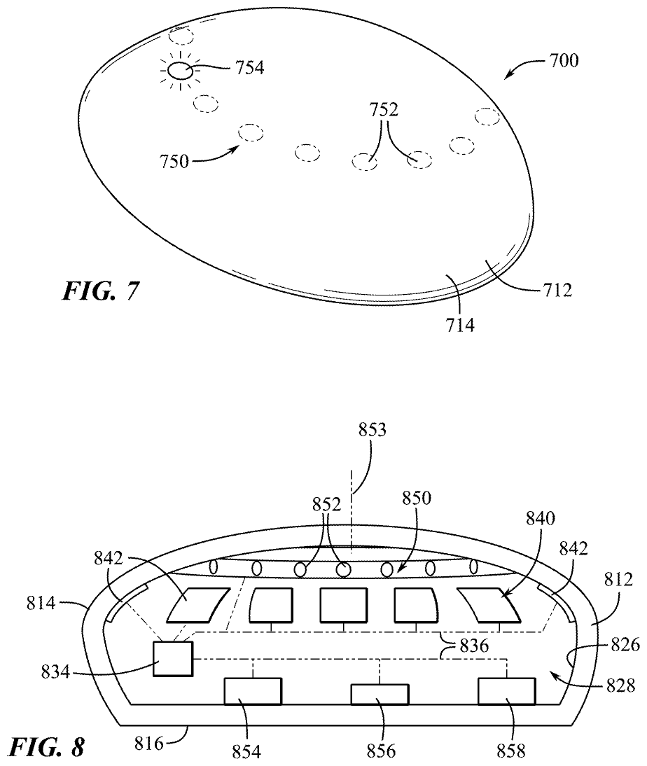

FIG. 7 illustrates a perspective view of a mouse 700 including a housing 712, a grip portion 714, a light sensor 750 disposed within the housing 712, and a “true north,” “user-facing,” or “forward” direction indicated by an illuminated LED 754, which light can be emitted from any of the LEDs 752 of the light sensor 750. The housing can be transparent or semi-transparent to the visible light spectrum produced by the light sensor 750. The light sensor 750 can produce light visible to a user when in use.

The light array 750 can react to user movement or indicate information or signals to a user. For example, the light array 750 may emit a certain color and or pattern in reaction to a first movement (e.g., a movement of the entire mouse 700 or a movement, tap, gesture, etc. of a user's finger, stylus, hand, or other tool as detected by the touch sensors 542), and a different color and/or pattern in reaction to a second movement (e.g., a different movement of the entire mouse, a different movement of the tool, or a detection of a different type of movement/by different type of sensor (i.e., switching from detecting a user's hand to detecting movement of the entire mouse)). In some examples, the light array may produce a sequence, such as a rotating circular pattern or a flashing/pulsating function. The light emitted to the user can indicate a confirmatory signal of the user's intent to switch operational modes. The operational mode of the mouse 700 can depend on a hand position of the user grasping the mouse 700, which can switch automatically upon sensing the contact between the user's hand and the housing 712 via the sensor assembly within the mouse 700. As noted above, the various operational modes of the mouse 700 can include a joystick mode, a dial mode, trackball mode, trackpad mode, a traditional mouse mode, or any other type of operational mode, depending on how the user grasps the mouse. In some embodiments, an additional three-dimensional mouse mode can also be detected based on signals indicating that the mouse has been grasped and picked up or otherwise moved vertically off of a support surface. The light array 750 can also indicate other communications or signals, including alerts, status, and other signals from the computing device or mouse.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

FIG. 8 shows a cross-sectional side view of a mouse 800 including a light array 850, a touch sensor assembly 840, a feedback module 854, an antenna 856, and an electrical component 858. The antenna can also be referred to as an emitter and/or a receiver. The electrical component 858 can include multiple components. The housing 812 can include an exterior surface 826, an interior surface 826, a grip portion 814, and a base 816. In one example, the sensor assembly 840 can include individual touch sensor elements 842 disposed circularly against the interior surface 826 of the housing 812. In one example, the light array 850 can include individual lights or LEDs 852 arranged circularly and against or near the interior surface 826 of the housing 812. The mouse 800 can also include a processor 834 electrically coupled or in communication with the other components via at least one electrical connection 836, including wires and other circuitry components. The processor 834 can thus be connected to the touch sensor assembly 840, the feedback module 854, the antenna 856, and the electrical component(s) 858. The processor 834 receives signals transmitted via the electrical connection 836 and can transmit, via the antenna 856, signals to the computing device and/or the computing device 102 signaling commands for the cursor 108.

The electrical component 858, processor 834, antenna 856, feedback module 854, touch sensor assembly 840, light array 850, and other electrical components of FIG. 8 can collectively form a computer system interconnected via a bus (e.g., via electrical connections 836) for electrical communication to a memory device, a power source, an electronic storage device, a network interface (e.g., a wireless interface via the antenna 856), an input device adapter, and an output device adapter. For example, one or more of these components can be connected to each other via a substrate (e.g., a printed circuit board or other substrate) supporting the bus and other electrical connectors providing electrical communication between the components. The bus can comprise a communication mechanism for communicating information between parts of the system.

The processor 834 can be a microprocessor or similar device configured to receive and execute a set of instructions stored by the memory of the electrical component 858. The memory can be referred to as main memory, such as random access memory (RAM) or another dynamic electronic storage device for storing information and instructions to be executed by the processor 834. The memory can also be used for storing temporary variables or other intermediate information during execution of instructions executed by the processor 834. The processor 834 can include one or more processors or controllers, such as, for example, a CPU for the mouse 700 and a touch controller or similar sensor or I/O interface used for controlling and receiving signals from the sensors being used (e.g., 842, any IMU or other orientation sensor, etc.). The power source of the electrical component 858 can comprise a power supply capable of providing power to the processor 834 and other components connected to the bus, such as a connection to an electrical utility grid or a battery system.

The storage device of the electrical component 858 can comprise read-only memory (ROM) or another type of static storage device coupled to the bus for storing static or long-term (i.e., non-dynamic) information and instructions for the processor. For example, the storage device can comprise a magnetic or optical disk (e.g., hard disk drive (HDD)), solid state memory (e.g., a solid state disk (SSD)), or a comparable device.

The instructions can comprise information for executing processes and methods using components of the system. Such processes and methods can include, for example, the methods described in connection with other embodiments elsewhere herein, including, for example, the methods and processes described in connection with FIGS. 9A-11B.

The network interface can comprise an adapter for connecting the system to an external device via a wired or wireless connection. For example, the network interface can provide a connection to a computer network such as a cellular network, the Internet, a local area network (LAN), a separate device capable of wireless communication with the network interface, other external devices or network locations, and combinations thereof. In one example embodiment, the network interface is a wireless networking adapter configured to connect via WI-FI®, BLUETOOTH®, BLE, Bluetooth mesh, or a related wireless communications protocol to another device having interface capability using the same protocol. In some embodiments, a network device or set of network devices in the network can be considered part of the system. In some cases, a network device can be considered connected to, but not a part of, the system.

The input device adapter can be configured to provide the system with connectivity to various input devices such as, for example, the touch sensor assembly 840, orientation sensor (e.g., 530), optical sensor, force sensor (e.g., 532a, 532b), related devices, and combinations thereof. The sensors can be used to detect physical phenomena (e.g., light, sound waves, electric fields, forces, vibrations, etc.) in the vicinity of the mouse (or caused by movement of the mouse) and convert those phenomena to electrical signals.

The output device adapter can be configured to provide the system with the ability to output information to a user, such as by providing visual output using one or more displays (e.g., light array 650/750/850 or an external display screen), by providing audible output using one or more speakers, or providing haptic feedback sensed by touch via one or more haptic feedback devices (e.g., 544). Other output devices can also be used. The processor 834 can be configured to control the output device adapter to provide information to a user via the output devices connected to the adapter.

In at least one example, the feedback module 854 can include a haptic mechanism such as a haptic engine. In at least one example, the feedback module 854 can include a speaker. In at least one example, the haptic module 854 can include a light. In at least one example, the electronic component 858 can include a memory component storing electronic instructions executable by the processor 834. In at least one example, in response to the sensor assembly 840 detecting a first touch input on the housing 812, the antenna 856 sends a first signal including information regarding an angular position of the grip portion 814 and, in response to the sensor assembly 840 detecting a second touch input on the housing 812, the antenna 856 sends a second signal including information regarding a direction of a force exerted on the housing 812 from the second touch input.

In at least one example, the housing 812 is symmetric (e.g., rotationally symmetric) about the central axis 853 oriented generally perpendicular to a surface on which the mouse 800 can rest or be manipulated. For example, the housing 812 can be circular with the central axis 853 being a central axis of rotation and/or symmetry of the mouse 800. In at least one example, the user can initially grasp the mouse 800, including the housing 812 thereof, in any orientation and have the mouse 800 be oriented as intended by the user based on the user's grip or hand position regardless of the actual orientation of the mouse 800, as described herein. In such an example, the processor 834 can determine the hand position and intended orientation of the mouse 800 based on the hand position of the user grasping the housing 812 via the touch sensor elements 842.

In at least one example, the housing 812 of the mouse 800 is circular or domed, as shown in FIG. 8, such that the housing 812 can be rotated about the central axis 853 serving as a central axis of rotation of the circular housing 812. In such an example, the mouse is agnostic to the actual orientation of the housing 812 relative to a support surface on which the housing 812 rests. Rather, the housing 812 can be oriented and/or re-oriented digitally or computationally by the processor 834 based on the hand position of the user, as detected by the touch sensor elements 842, without the need to physically move or rotate the mouse 800 upon grasping the housing 812.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8.

FIG. 9A illustrates a mouse 900 manipulated by a user's hand 960, the user's hand 960 gripping the grip portion 914 of the housing 912 of the mouse 900. The circular profile of the mouse 900 enables the user to grip the mouse 900 from any direction while the mouse 900 interprets touch points or contact areas from the hand 960 and fingers 962 via the sensors in the sensor array, such as sensor elements 842 of sensor array 840 shown in the mouse 800 of FIG. 8. The sensor elements determine placement and positioning of the hand 960 and fingers 962 on the mouse 900 to dynamically orient the mouse 900 based on sensorally determining the user hand 960 and finger 962 positioning on the grip portion 914 of the mouse 900. The user's hand 954 can be a left hand or a right hand depending on user preference. The mouse 900 can detect either a left hand or right hand placement dynamically providing convenience and efficiency for multi-handed users or multiple different users of the same mouse 900.

In one example, a user may grip the grip portion 914 of the mouse 900. A plurality of touch sensors can detect a first hand position, such as the user initially gripping the grip portion 914. The emitter 546 can send the information regarding a direction of force applied on the grip portion 914 detected by the force sensors (e.g. force vector sensors) 532. When the plurality of touch sensors 840 detects a second hand position, for example, the user adjusting their hand 960 or fingers 962 on the mouse 900, the emitter sends information regarding an orientation of the mouse 900. The orientation of the mouse 900 can be determined by the orientation sensor 330 and transmitted via the emitter 546.

FIG. 9B shows a top view of the mouse 900 and the housing 912 including the grip portion 914. Contact regions 964a-f representing detected contact between the user's hand 960 and fingers/thumb 962 and the mouse 900 are shown in broken lines to illustrate the general contact areas between the hand and housing 912. In the illustrated example, the detected touch regions 964a-f can include a first finger sensor contact region 964a, a second finger sensor contact region 964b, a third finger sensor contact region 964c, a fourth finger contact region 964d, a fifth finger contact region 964e, and a palm sensor contact region 964f. As noted above with reference to other examples, the mouse 900 shown in FIGS. 9A-9B can be equipped with sensors and sensor arrays to detect the touch regions of the user's hand 960 (e.g., palm) and fingers/thumb 962. The contact regions 964a-f can be collectively referred to as a contact profile 964.

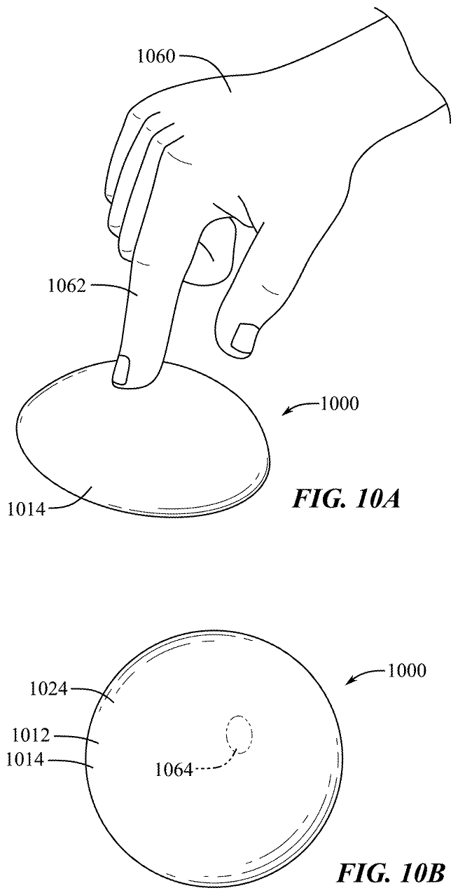

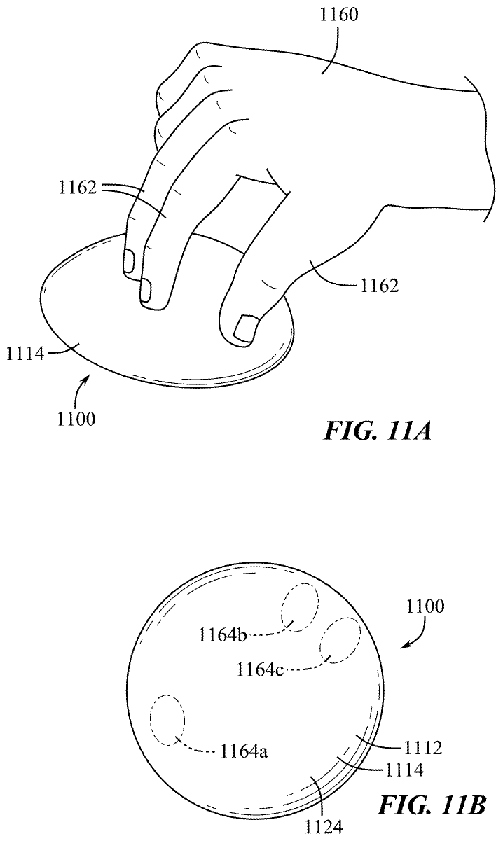

The contact profile 964 includes sensor readings from portions of the hand 960 in contact with the mouse 900. For example, a user may grip the mouse 900 with all his or her fingers 962 as well as with a portion of the palm, creating the sensor contact profile illustrated in FIG. 9B. The first contact region 964a representing a first finger 962 contacting the mouse 900 can vary from the second contact region 964b resulting in unique sensor profiles for each finger and/or palm in contact with the outer surface of the housing 912 of the mouse 900. For example, the sensor profile 964 can be a real-time capacitive reading of the finger based on unique user hand contact characteristics, for example: finger contact length, finger contact width, finger contact cross-sectional area, and so forth. These hand contact characteristics are used by at least the first touch sensor configured to detect a first response at a first location, for example, to identify/detect the first contact region 964a, on the grip portion 914 and the second touch sensor configured to detect a second touch response at a second location, for example the second finger contact region 964b, on the exterior surface. In this way, an intended operational mode of the mouse 900 can be determined automatically. Examples of different intended operational modes corresponding to different contact profiles are illustrated in more detail below with reference to FIGS. 10A-11B.

In the illustrated example of 9B, the contact profile detected as a combination of contact regions 964a-f can indicate an intent by the user to operate the mouse 900 in a traditional mode where the mouse 900 is slid back and forth, left and right on a support surface such as a mousepad or desktop surface. The contact profile 964 illustrated in FIG. 9B can be referred to as a conventional mouse grip configuration, a full hand grasping configuration, a “pinch grip” configuration, or a “claw grip” configuration that, when detected, causes the system to enable usage of the mouse 900 if it were a conventional mouse with buttons (e.g., interpreting certain input (such as a tap on designated parts of the outer surface while maintaining a minimum amount of contact with the mouse with other parts of the hand or on other parts of the mouse) as an input intended by the user to imitate actuation of a left click button, a right click button, a middle click button, side mouse buttons, etc.). Similarly, after detecting a conventional mouse grip by the user, the system can interpret certain gestures on a designated part of the outer surface of the mouse 900 as inputs intended by the user to imitate usage of a touchpad/trackpad or mouse wheel (e.g., interpreting 1-3 fingers dragging on the top surface to enable scrolling, zooming, control of user interface elements (e.g., window control functions)). In one example, the system can identify that the user intends to use the mouse as a conventional mouse while the user maintains consistent thumb contact (e.g., at 964a) and at least one opposite finger contact (e.g., at 964d or 964e) with the mouse, and other fingers (e.g., at 964b-d) can be moved or not sensed without altering the system's touch interpretation mode. The processor of the mouse 900 (or a computing device in electronic communication with the mouse) can identify the contact profile and correlate it to a user intent via preset instructions or, in one or more other examples, the memory component of the mouse 900 can include instructions to carry out machine learning algorithms to learn the user's intent based on the contact profiles and movements of each user over time.

Any of the features, components, and/or parts, including the arrangements and configurations thereof shown in FIGS. 9A-9B, can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 9A-9B.

FIG. 10A illustrates a user's hand 1060 touching a grip portion 1014 of a mouse 1000 with a single finger 1062. In the illustrated example, the contact profile can include a detected touch input in a single touch input location represented by the contact region 1064 shown in FIG. 10B. In at least one example, the sensors and sensor assemblies disclosed herein with reference to other examples and other figures can include touch sensors disposed anywhere against the grip portion 1014, including in a central upper location where the user presses a single finger as shown in FIG. 10B. The locations and configuration of multiple sensor elements of the touch sensor assemblies disclosed herein and shown in the figures are exemplary and not meant to be limiting. One or more other examples, including the example shown in FIG. 10B, can include touch sensor assemblies having touch sensors and elements disposed anywhere within the device such that a single finger touch or multiple finger touch anywhere on the grip portion 1014 can be detected.

The sensor assembly detecting the single touch input can transmit, via the force sensor(s) of the mouse 1000, the angular position and force applied by the finger 1062 at the contact region 1064 to the processor. The processor can then process and transmit the received touch input location and vector information to operate the mouse 1000 in a “joystick” mode. That is, the single finger touch can be detected and the user can operate the mouse 1000 as if operating a joystick by changing a direction of a force on the grip portion 1014 (e.g., by tilting the user's finger while the fingertip remains substantially stationary or by varying the predominant direction in which pressure is being applied by the finger while the fingertip is in a single position 1064, similar to an “eraser head”-type mouse). Rather than operating in a traditional mode, where the mouse 1000 must be moved on a support surface, the mouse 1000 can automatically switch to a joystick mode to detect the direction of the force applied by the finger 1062 so that the user can control a cursor on a screen via the mouse 1000 as if the mouse 1000 were a joystick.

The contact profile, including the single contact region 1064 shown in FIG. 10B, can correspond to a user's intent to operate the mouse 1000 in a joystick mode. However, the illustrated contact profile is exemplary only and not meant to be limiting. Other contact profiles including multiple contact regions at certain other locations on the grip portion 1014 of the mouse 1000 can also be indicative of a user's intent to operate the mouse 1000 in joystick mode, such as two to five fingers touching the top of the mouse in a bunched together or clustered formation within a single contact region (e.g., 1064). Other modes of operation are also contemplated herein. The finger 1062 can be detected via a touch sensor (e.g., from the sensor assembly 840).

Any of the features, components, and/or parts, including the arrangements and configurations thereof shown in FIGS. 10A-10B, can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 10A-10B.

FIG. 11A illustrates a user's hand 1160 touching a grip portion 1114 of a mouse 1100 with multiple fingers 1162. In the illustrated example, the contact profile can include a detected touch input in multiple spaced apart touch input locations represented by the contact regions 1164a, 1164b, and 1164c shown in FIG. 11B. These contact regions 1164a-c can correspond to locations of contact between the user's fingers 1162 shown in FIG. 11A and the housing 1112 of the mouse 1100. The contact regions 1164a-c can differ from the contact regions 964a-f (see FIG. 9B) due to their positioning on the surface (i.e., positioned higher up on the outer surface than a claw grip configuration), the number of contacts (i.e., 2-3 versus 5 or more), the type of contacts (e.g., finger-sized contact areas 1164a-c versus palm-sized 9640. The sensor assembly detecting the single touch input can transmit, via the force sensor(s) of the mouse 1100, the angular position and force profiled by the fingers 1162 at the contact regions 1164a-c to the processor. The processor can then process and transmit the received touch input location and vector information to operate the mouse 1100 in a turn-knob or dial mode. That is, the specific combination of detected contact regions 1164a-c can indicate an intent of the user to operate the mouse 1100 as a dial. In such an operational mode, the user can rotate the mouse 1100 as if it were a turnable dial, to control a cursor or scroll through menu items within a GUI displayed on a screen. In this way, the mouse can automatically switch into dial mode based on the hand position of the user.

The mouse 1100 shown in FIGS. 11A and 11B can include any or all of the component of other examples of mice shown in other figures and described herein. For example, the mouse 1100 can include one or more orientation sensors, including IMU sensors, angular sensors, accelerometers, and so forth, to detect an orientation of the mouse 1100 relative to a starting orientation or position as the user twists the mouse in dial mode.

The contact profile, including the three contact regions 1164a-c shown in FIG. 11B, can correspond to a user's intent to operate the mouse 1100 in a dial mode. However, the illustrated contact profile is exemplary only and not meant to be limiting. Other contact profiles including one or multiple contact regions at certain other locations on the grip portion 1114 of the mouse 1100 can also be indicative of a user's intent to operate the mouse 1100 in dial mode. Other modes of operation are also contemplated herein. Accordingly, the touch sensor array of the mouse 1100 can include a plurality of capacitive sensing elements configured to detect the first touch input including the first contact profile shown in FIG. 10B and a second touch input including the second contact profile shown in FIG. 11B.

Any of the features, components, and/or parts, including the arrangements and configurations thereof shown in FIGS. 11A-11B, can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 11A-11B.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. An input device, comprising:
a housing having an interior surface defining an internal volume;
a touch sensor assembly including an array of capacitive sensing elements disposed against the interior surface;
an orientation sensor disposed in the internal volume; and
a force sensor assembly configured to detect a direction of a force exerted on the housing.

2. The input device of claim 1, wherein:
the touch sensor assembly is configured to:
detect a first hand position of a user touching the housing based on a first set of capacitive sensing elements detecting contact between the hand and the housing; and
detect a second hand position of a user touching the housing based on a second set of capacitive sensing elements detecting contact between the hand and the housing; and
the orientation sensor detects a rotation of the input device in response to detecting the first hand position; and
the force sensor detects the direction of the force exerted on the housing in response to detecting the second hand position.

3. The input device of claim 2, wherein the housing includes an interior surface defining the internal volume and the touch sensor assembly includes two sensor elements disposed on the interior surface.

4. The input device of claim 1, wherein the force sensor assembly includes two force sensors.

5. The input device of claim 1, wherein the orientation sensor includes an inertial measurement unit (IMU).

6. The input device of claim 1, further comprising a feedback module.

7. The input device of claim 6, wherein the feedback module includes at least one of:
a haptic mechanism;
a light; or
a speaker.

8. The input device of claim 6, wherein the housing is circular about a central axis.

9. The input device of claim 6, wherein:
the input device further comprises a processor electrically coupled to the touch sensor assembly; and
the processor is configured to determine an intended orientation of the housing based on a hand position of a user detected by the touch sensor assembly.

10. A mouse, comprising:
a housing including a base and a grip portion coupled to the base;
a plurality of touch sensors disposed on the grip portion; and
a force sensor disposed on the base portion, the force sensor sensitive to a direction and magnitude of a force applied to the grip portion.

11. The mouse of claim 10, wherein the plurality of touch sensors are configured to detect positions of a hand contacting the grip portion.

12. The mouse of claim 11, further comprising a processor in electrical communication with the plurality of touch sensors and the force sensor.

13. The mouse of claim 12, further comprising an emitter electrically coupled to the processor and a memory component storing electronic instructions that, when executed by the processor, cause the emitter to:
in response to the plurality of touch sensors detecting a first hand position of the positions, send a first signal including first information regarding a direction of force applied on the grip portion detected by the force vector sensor; and
in response to the plurality of touch sensors detecting a second hand position contacting the grip portion, send a second signal including second information regarding an orientation of the mouse.

14. The mouse of claim 13, further comprising an orientation sensor electrically coupled to the processor.

15. A mouse, comprising:
a housing defining an exterior grip portion and an internal volume;
a sensor assembly disposed in the internal volume; and
an emitter electrically coupled to the sensor assembly;
wherein:
in response to the sensor assembly detecting a first touch input on the housing, the emitter sends a first signal including information regarding an angular position of the grip portion; and
in response to the sensor assembly detecting a second touch input on the housing, the emitter sends a second signal including information regarding a direction of a force exerted on the housing from the second touch input.

16. The mouse of claim 15, wherein the first touch input includes a set of touch input locations on the housing.

17. The mouse of claim 15, wherein the second touch input includes a single touch input location.

18. The mouse of claim 15, wherein the sensor assembly comprises:
a force vector sensor;
a touch sensor array; and
an angular sensor.

19. The mouse of claim 18, wherein the touch sensor array includes a plurality of capacitive sensing elements configured to detect the first touch input and the second touch input.

20. The mouse of claim 18, wherein the force vector sensor includes a first force sensor disposed at a first location within the internal volume and a second force sensor disposed at a second location within the internal volume.
